(19) United States
(12) Patent Application Publication
(10) Pub. No.: US 2013/0043727 A1
(43) Pub. Date: Feb. 21, 2013

(54) POWER SUPPLY APPARATUS

(71) Applicants: Change-Yuan Liu, Taoyuan County (TW); Chuan-Kai Wang, Taoyuan County (TW)

(72) Inventors: Change-Yuan Liu, Taoyuan County (TW); Chuan-Kai Wang, Taoyuan County (TW)

(73) Assignee: 3Y POWER TECHNOLOGY (TAIWAN), INC., Taoyuan County (TW)

(21) Appl. No.: 13/586,877

(22) Filed: Aug. 16, 2012

(30) Foreign Application Priority Data
Aug. 19, 2011 (TW) 100129764

(51) Int. Cl. G05F 1/563

(52) U.S. Cl. 307/31

(57) ABSTRACT

A power supply apparatus is provided, which includes an input conversion stage, a main power conversion circuit, an auxiliary power conversion circuit, a switching unit and a buck power conversion circuit. The input conversion stage is used for receiving an AC voltage and converting the AC voltage to output a DC input voltage. The main power conversion circuit is used for converting the DC input voltage so as to generate and output a main power. The auxiliary power conversion circuit is used for converting the DC input voltage so as to generate and output an auxiliary power. The switching unit is used for receiving the main power and the auxiliary power and selecting and outputting one of the main power and the auxiliary power. The buck power conversion circuit is used for stepping down the output of the switching unit so as to generate and output a standby power.

### CROSS-REFERENCE TO RELATED APPLICATION

This application claims the priority benefit of Taiwan application serial no. 100129764, filed on Aug. 19, 2011. The entirety of the above-mentioned patent application is hereby incorporated by reference herein and made a part of this specification.

### BACKGROUND OF THE INVENTION

1. Field of the Invention

The present invention relates to a power supplying technique, and more particularly, to a power supply apparatus applicable to a computer system.

2. Description of Related Art

FIG. 1 is a diagram of a conventional power supply apparatus 100 of a computer system. Please refer to FIG. 1. The power supply apparatus 100 includes an input conversion stage 110, a main power conversion circuit 120, an auxiliary power conversion circuit 130 and a standby power generating circuit 140. Herein the input conversion stage 110 is used to receive an AC voltage AC_IN and convert the received AC voltage to output a DC input voltage DC_IN. The main power conversion circuit 120 is used to convert the DC input voltage DC_IN so as to generate and output a main power P_main. The auxiliary power conversion circuit 130 is used to convert the DC input voltage DC_IN so as to generate and output an auxiliary power P_aux. The standby power generating circuit 140 is used to directly convert the auxiliary power P_aux so as to generate and output a standby power P_sb.

In general, the function of the auxiliary power conversion circuit 130 is to assist the activation of the main power conversion circuit 120, and provides the auxiliary power P_aux so as to make the standby power generating circuit 140 generate the standby power P_sb. However, the circuit topology (configuration) of the auxiliary power conversion circuit 130 is generally the flyback power conversion circuit, such that the whole efficiency of the power supply apparatus 100 may reduce due to the inferior conversion efficiency of the flyback power conversion circuit (about 70% to 75%). Thus, the power supply apparatus 100 may generate much more ineffective power and it is not conducive to power saving.

### SUMMARY OF THE INVENTION

Accordingly, the present invention provides a power supply apparatus capable of resolving the disadvantages in the related art.

The power supply apparatus of the present invention includes an input conversion stage, a main power conversion circuit, an auxiliary power conversion circuit, a switching unit and a buck power conversion circuit. Herein the input conversion stage is used to receive an AC voltage and convert the AC voltage to output a DC input voltage. The main power conversion circuit is coupled to the input conversion stage and used to convert the DC input voltage so as to generate and output a main power. The auxiliary power conversion circuit is coupled to the input conversion stage and used to convert the DC input voltage so as to generate and output an auxiliary power. The switching unit is coupled to the main power conversion circuit and the auxiliary power conversion circuit, and used to receive the main power and the auxiliary power and select and output one of the main power and the auxiliary power. The buck power conversion circuit is coupled to the switching unit, and used to step down the output of the switching unit so as to generate and output a standby power.

According to an embodiment of the present invention, in an activation state of the power supply apparatus, the auxiliary power has a higher priority than the main power to be generated. In addition, in an operation state of the power supply apparatus, the main power is generated in response to the generation of the auxiliary power. Herein the main power is greater than the auxiliary power.

According to an embodiment of the present invention, in the activation state, the switching unit outputs the auxiliary power to the buck power conversion circuit. In addition, in the operation state, the switching unit outputs the main power to the buck power conversion circuit.

According to an embodiment of the present invention, the switching unit includes a first diode and a second diode. The anode of the first diode is used to receive the main power, and the cathode of the first diode is coupled to the input of the buck power conversion circuit. The anode of the second diode is used to receive the auxiliary power, and the cathode of the second diode is coupled to the input of the buck power conversion circuit.

According to an embodiment of the present invention, the switching unit further selects and outputs one of the main power and the auxiliary power in response to a first control signal and a second control signal. Under this condition, the switching unit includes a first switch and a second switch. Herein the first switch is used to receive the main power, wherein whether the first switch is turned on in response to the first control signal. The second switch is used to receive the auxiliary power, wherein whether the second switch is turned on in response to the second control signal. Herein the first switch is turned off in the activation state of the power supply apparatus, and turned on in the operation state of the power apparatus. And the second switch is turned on in the activation state of the power supply apparatus, and turned off in the operation state of the power supply apparatus.

According to an embodiment of the present invention, the power supply apparatus further includes a control unit. The control unit is coupled to the main power conversion circuit, the auxiliary power conversion circuit and the switching unit, and used to generate the first control signal and the second control signal in response to the main power and the auxiliary power.

According to an embodiment of the present invention, the main power conversion circuit can be a forward power conversion circuit, a flyback power conversion circuit, an active clamp and half bridge power conversion circuit, an active clamp and full bridge power conversion circuit, or a push-pull power conversion circuit.

According to an embodiment of the present invention, the auxiliary power conversion circuit can be a flyback power conversion circuit.

From the above, in the present invention, the switching unit is used to output the auxiliary power to the buck power conversion circuit for generating the standby power in the activation state of the power supply apparatus. In addition, in the operation state of the power supply apparatus, the switching unit outputs the main power to the buck power conversion circuit for generating the standby power. Since the auxiliary power conversion circuit is completely operated only in the activation state of the power supply apparatus, the whole efficiency of the power supply apparatus (just for the activation state of the power supply apparatus) is improved because of the superior conversion efficiency of the buck power conversion circuit (about 93% to 97%). Thus, the power supply may not generate much ineffective power and it is conducive to power saving.

However, the above descriptions and the below embodiments are only used for explanation, and they do not limit the scope of the present invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional power supply apparatus of a computer system.

FIG. 2 is a diagram of a power supply apparatus according to an embodiment of the present invention.

FIG. 3 is a diagram of an input conversion stage in FIG. 2.

FIG. 4 is an implementation diagram of a switching unit in FIG. 2.

FIG. 5A is a diagram of a power supply apparatus according to another embodiment of the present invention.

FIG. 5B is a diagram of the switching unit in FIG. 5A.

FIG. 6A, FIG. 6B, FIG. 6C, FIG. 6D and FIG. 6E respectively are implementation diagrams of a switching unit in FIG. 5B.

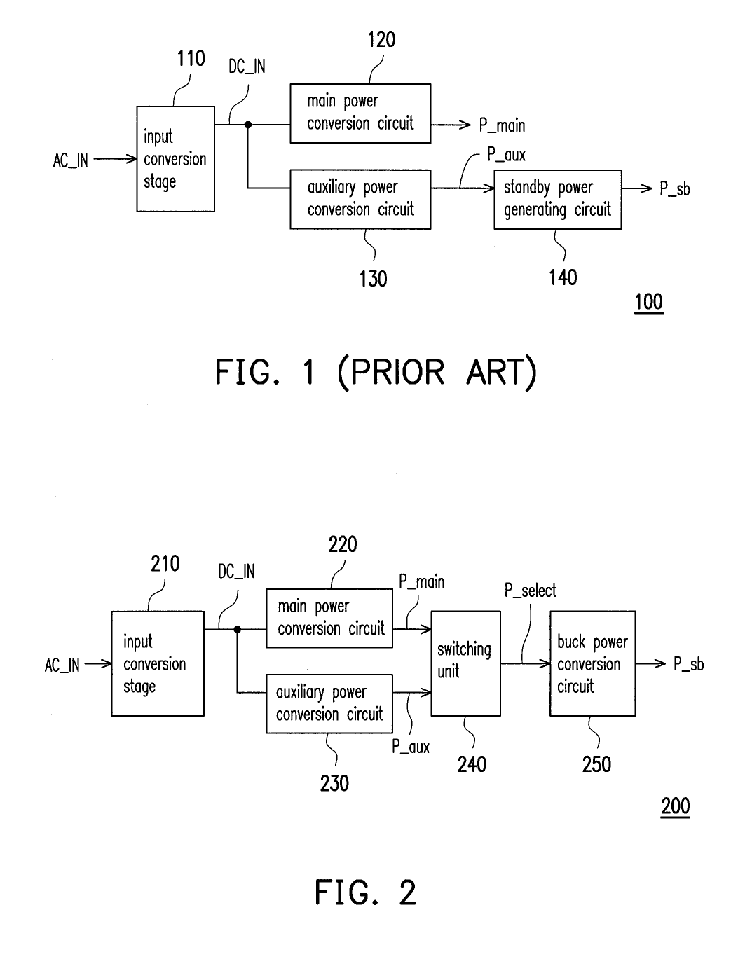

### DESCRIPTION OF EMBODIMENTS

Descriptions of the invention are given with reference to the exemplary embodiments illustrated with accompanied drawings, wherein same or similar parts are denoted with same reference numerals. In addition, whenever possible, identical or similar reference numbers stands for identical or similar elements in the figures and the embodiments.

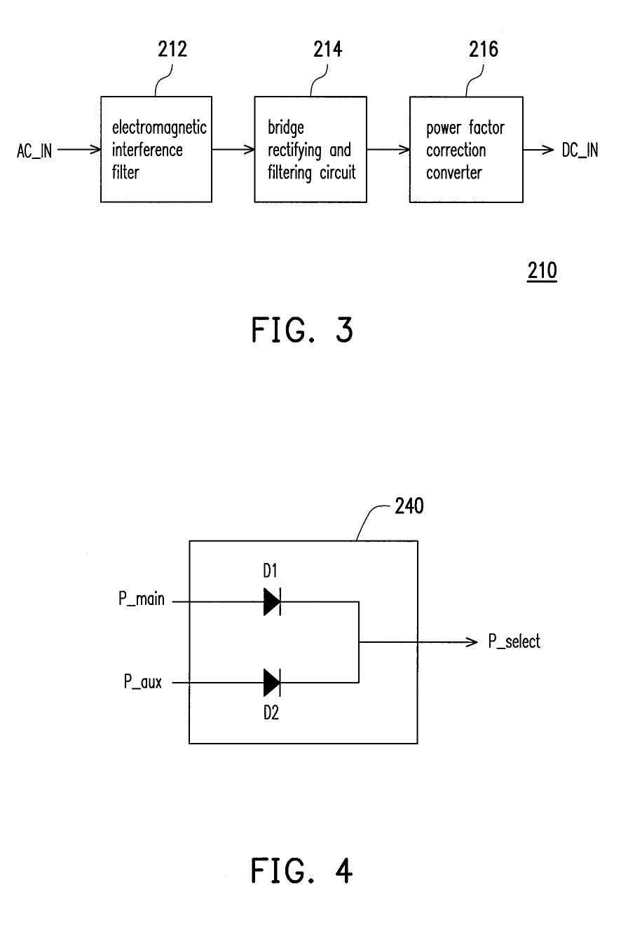

FIG. 2 is a diagram of a power supply apparatus 200 according to an embodiment of the present invention. Referring to FIG. 2, the power supply apparatus 200 is applicable to a computer system, but not limited thereto. The power supply apparatus 200 includes an input conversion stage 210, a main power conversion circuit 220, an auxiliary power conversion circuit 230, a switching unit 240 and a buck power conversion circuit 250. In the embodiment, the input conversion stage 210 is used to receive an AC voltage AC_IN (e.g., city power, but not limited thereto) and convert the AC voltage AC_IN to output a DC input voltage DC_IN.

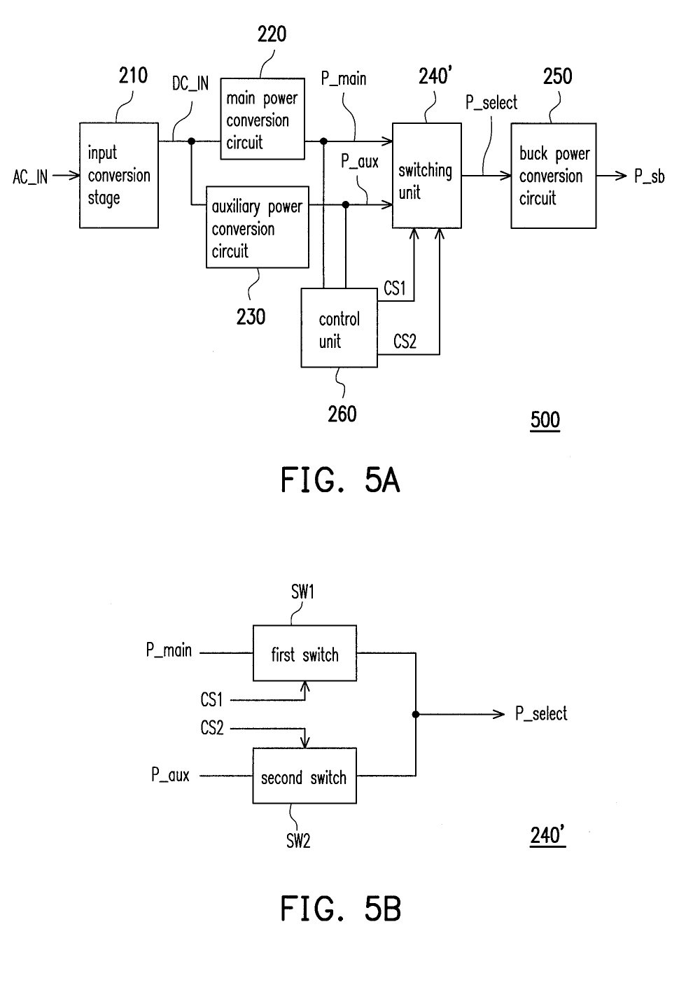

More specifically, FIG. 3 is a diagram of the input conversion stage 210 in FIG. 2. Referring to FIG. 2 and FIG. 3 together, the input conversion stage 210 may include an electromagnetic interference filter (EMI filter) 212, a bridge rectifying and filtering circuit 214 and a power factor correction converter (PFC converter) 216. The EMI filter 212 is coupled between the AC voltage AC_IN and the bridge rectifying and filtering circuit 214, and used to suppress the electromagnetic noise of the AC voltage AC_IN. The bridge rectifying and filtering circuit 214 is used to receive the AC voltage AC_IN and perform full wave rectifying and filtering on the AC voltage AC_IN, so as to output the DC input voltage DC_IN. The PFC converter 216 is coupled to the bridge rectifying and filtering circuit 214 and used to perform power factor correction on the output (i.e., the DC input voltage DC_IN) of the bridge rectifying and filtering circuit 214.

On the other hand, the main power conversion circuit 220 is coupled to the input conversion stage 210 and used to convert the DC input voltage DC_IN output by the input conversion stage 210 so as to generate and output a main power P_main. In addition, the auxiliary power conversion circuit 230 is coupled to the input conversion stage 210 and used to convert the DC input voltage DC_IN output by the input conversion stage 210 so as to generate and output an auxiliary power P_aux.

In the embodiment, the circuit topology of the main power conversion circuit 220 can be a forward power conversion circuit, a flyback power conversion circuit, an active clamp and half bridge power conversion circuit, an active clamp and full bridge power conversion circuit, or a push-pull power conversion circuit, but not limited thereto. Moreover, the circuit topology of the auxiliary power conversion circuit 230 can be a flyback power conversion circuit. However, the structure and operating method of the various power conversion circuits mentioned above are well known for people skill in the art, and thus the detail descriptions are not illustrated herein.

The switching unit 240 is coupled to the main power conversion circuit 220 and the auxiliary power conversion circuit 230, and used to receive the main power P_main output by the main power conversion circuit 220 and the auxiliary power P_aux output by the auxiliary power conversion circuit 230, and select and output one of the main power P_main and the auxiliary power P_aux. The buck power conversion circuit 250 is coupled to the switching unit 240, and used to step down the output of the switching unit 240 so as to generate and output a standby power P_sb.

In the embodiment, the power supply apparatus 200 has an activation state and an operation state. In the activation state of the power supply apparatus 200, the auxiliary power P_aux has a higher priority than the main power P_main to be generated. In addition, in the operation state of the power supply apparatus 200, the main power P_main is generated in response to the generation of the auxiliary power P_aux. In other words, the auxiliary power P_aux is used to assist the activation of the main power conversion circuit 220 to generate the main power P_main. Herein the main power P_main is greater than the auxiliary power P_aux. For instance, if it is designed in a principle that the auxiliary power P_aux is 5% of the minimum regulated power rate, then, when the main power P_main is 12V, the auxiliary power P_aux can be 11.4V (12V×95%=11.4V). But the design of the main power P_main and the auxiliary power P_aux is not limited thereto.

On the other hand, in the activation state of the power supply apparatus 200, the switching unit 240 outputs the auxiliary power P_aux to the buck power conversion circuit 250. In the operation state of the power supply apparatus 200, the switching unit 240 outputs the main power P_main to the buck power conversion circuit 250. That means, in the activation state of the power supply apparatus 200, the output P_select of the switching unit 240 is the auxiliary power P_aux, while in the operation state of the power supply apparatus 200, the output P_select of the switching unit 240 is the main power P_main. Therefore, the buck power conversion circuit 250 may step down the output P_select (whether the auxiliary power P_aux or the main power P_main) of the switching unit 240 so as to generate and output the standby power P_sb (e.g., 5V, but is not limited thereto).

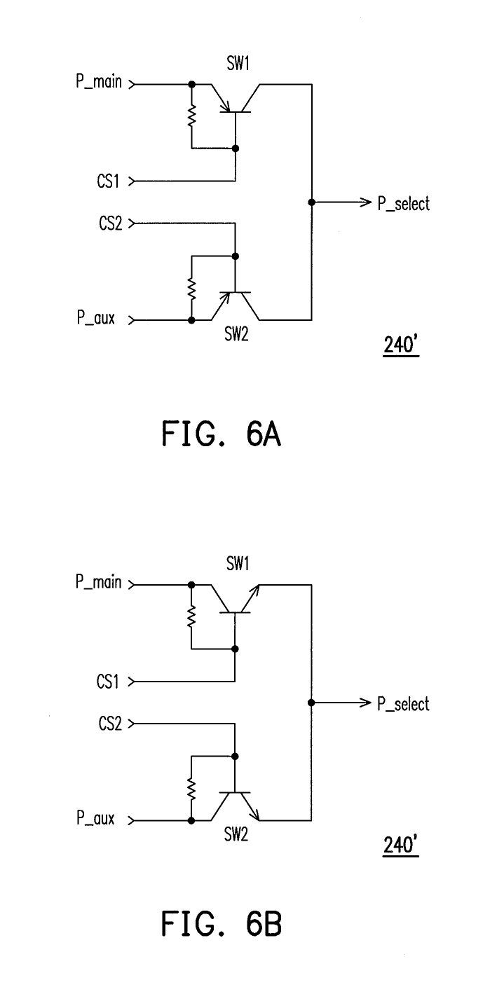

FIG. 4 is an implementation diagram of the switching unit 240 in FIG. 2. Referring to both FIG. 2 and FIG. 4, the switching unit 240 includes two diodes D1 and D2. Herein the anode of the first diode D1 is used to receive the main power P_main, and the cathode of the first diode D1 is coupled to the input of the buck power conversion circuit 250. In addition, the anode of the second diode D2 is used to receive the auxiliary power P_aux, and the cathode of the second diode D2 is coupled to the input of the buck power conversion circuit 250.

In the embodiment, in the activation state of the power supply apparatus 200, since the main power P_main has not been generated, just the diode D2 is turned on for transmitting the auxiliary power P_aux to the buck power conversion circuit 250. And in the operation state of the power supply apparatus 200, since the main power P_main has been generated, just the diode D1 is turned on for transmitting the main power P_main to the buck power conversion circuit 250. In this way, the buck power conversion circuit 250 may step down the output P_select (whether the auxiliary power P_aux corresponding to the activation state or the main power P_main corresponding to the operation state) of the switching unit 240 so as to generate and output the standby power P_sb.

It can be clearly known that, the auxiliary power conversion circuit 230 is completely operated just in the activation state of the power supply apparatus 200. And the auxiliary power conversion circuit 230 is operated under a sleep mode in the operation state of the power supply apparatus 200 due to the output loading of the auxiliary power conversion circuit 230 in this time can be regarded as a no load condition. Obviously, in the operation state of the power supply apparatus 200, the auxiliary power conversion circuit 230 having the inferior conversion efficiency would be turned off, and the buck power conversion circuit 250 having the superior conversion efficiency would generate the standby power P_sb in response to the main power P_main. Thus, the whole efficiency of the power supply apparatus 200 (just for the activation state of the power supply apparatus 200) is improved because of the superior conversion efficiency of the buck power conversion circuit 250 (about 93% to 97%), and the power supply apparatus 200 may not generate much ineffective power and it is conducive to power saving.

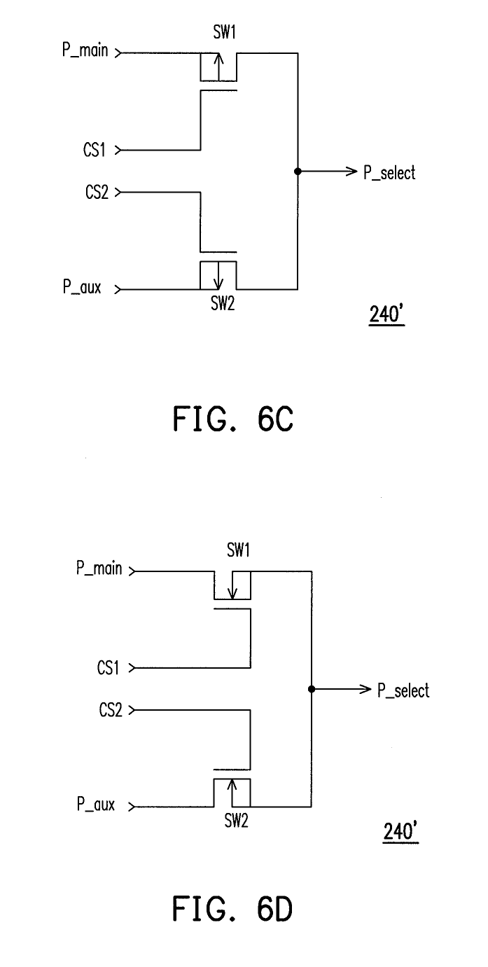

In addition, FIG. 5A is a diagram of a power supply apparatus 500 according to another embodiment of the present invention. Referring to FIG. 2 and FIG. 5A, compared the power supply apparatus 500 with the power supply apparatus 200, the difference therebetween is that the power supply apparatus 500 further has a control unit 260 and the implementations of the switching units 240 and 240′ are different. Herein the control unit 260 is coupled to the main power conversion circuit 220, the auxiliary power conversion circuit 230 and the switching unit 240′. And the control unit 260 is used to generate a first control signal CS1 and a second control signal CS2 in response to the main power P_main and the auxiliary power P_aux. Accordingly, the switching unit 240′ further selects and outputs one of the received main power P_main and the received auxiliary power P_aux in response to the first control signal CS1 and the second control signal CS2 from the control unit 260.

Specifically, FIG. 5B is a diagram of the switching unit 240′ in FIG. 5A. Referring to FIGS. 5A and 5B, the switching unit 240′ includes a first switch SW1 and a second switch SW2. Herein the first switch SW1 is used to receive the main power P_main, wherein whether the first switch SW1 is turned on in response to the first control signal CS1 from the control unit 260. Relatively, the second switch SW2 is used to receive the auxiliary power P_aux, wherein whether the second switch SW2 is turned on in response to the second control signal CS2 from the control unit 260. In the embodiment, the first switch SW1 is turned off in the activation state of the power supply apparatus 500, and turned on in the operation state of the power supply apparatus 500. And the second switch SW2 is turned on in the activation state of the power supply apparatus 500, and turned off in the operation state of the power supply apparatus 500.

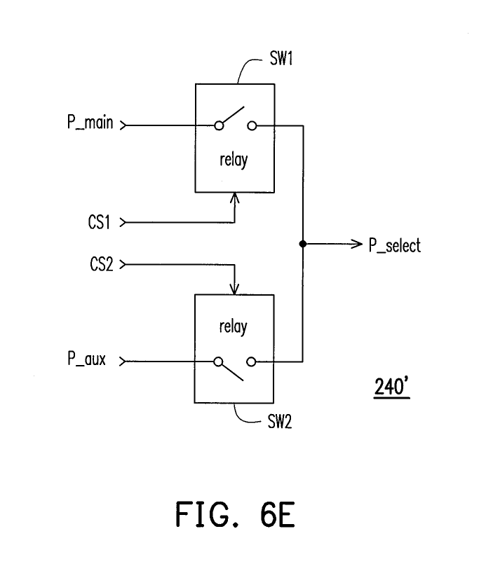

Accordingly, FIG. 6A, FIG. 6B, FIG. 6C, FIG. 6D and FIG. 6E respectively are implementation diagrams of the switching unit 240′ in FIG. 5B. Referring to FIG. 5B, FIGS. 6A to 6E, in the embodiment, the first switch SW1 and the second switch SW2 can be implemented by PNP transistors (as shown in FIG. 6A), or can be implemented by NPN transistors (as shown in FIG. 6B), or can be implemented by PMOS transistors (as shown in FIG. 6C), or can be implemented by NMOS transistors (as shown in FIG. 6D), or can be implemented by relays (as shown in FIG. 6E), but the present invention is not limited thereto and it depends on the design requirement.

In the activation state of the power supply apparatus 500, since the main power P_main has not been generated, accordingly the control unit 260 may generate the first control CS1 and the second control signal CS2 to turn the first switch SW1 off and turn the second switch SW2 on. Therefore, the auxiliary power P_aux would be transmitted to the buck power conversion circuit 250. In the operation state of the power supply apparatus 500, since the main power P_main has been generated, accordingly the control unit 260 may generate the first control CS1 and the second control signal CS2 to turn the first switch SW1 on and turn the second switch SW2 off. Therefore, the main power P_main would be transmitted to the buck power conversion circuit 250. In this way, the buck power conversion circuit 250 may step down the output P_select (whether the auxiliary power P_aux corresponding to the activation state or the main power P_main corresponding to the operation state) of the switching unit 240′ so as to generate and output the standby power P_sb.

Similarly, the auxiliary power conversion circuit 230 is completely operated only in the activation state of the power supply apparatus 500. And the auxiliary power conversion circuit 230 is operated under a sleep mode in the operation state of the power supply apparatus 500 due to the output loading of the auxiliary power conversion circuit 230 in this time can be regarded as a no load condition. Obviously, in the operation state of the power supply apparatus 500, the auxiliary power conversion circuit 230 having the inferior conversion efficiency would be turned off, and the buck power conversion circuit 250 having the superior conversion efficiency would generate the standby power P_sb in response to the main power P_main. Thus, the whole efficiency of the power supply apparatus 500 (just for the activation state of the power supply apparatus 500) is improved because of the superior conversion efficiency of the buck power conversion circuit 250 (about 93% to 97%), and the power supply apparatus 500 may not generate much ineffective power and it is conducive to power saving.

In light of the foregoing, in the present invention, the switching unit is used to output the auxiliary power to the buck power conversion circuit for generating the standby power in the activation state of the power supply apparatus. In addition, in the operation state of the power supply apparatus, the switching unit outputs the main power to the buck power conversion circuit for generating the standby power. Since the auxiliary power conversion circuit is completely operated only in the activation state of the power supply apparatus, the whole efficiency of the power supply apparatus (just for the activation state of the power supply apparatus) is improved because of the superior conversion efficiency of the buck power conversion circuit (about 93% to 97%). Thus, the power supply apparatus may not generate much ineffective power and it is conducive to energy saving.

The embodiments described hereinbefore are chosen and described in order to best explain the principles of the invention and its best mode practical application. It is not intended to be exhaustive to limit the invention to the precise form or to the exemplary embodiments disclosed. Namely, persons skilled in the art are enabled to understand the invention through various embodiments with various modifications as are suited to the particular use or implementation contemplated. It is intended that the scope of the invention be defined by the claims appended hereto and their equivalents in which all terms are meant in their broadest reasonable sense unless otherwise indicated. Any of the embodiments or any of the claims of the invention does not need to achieve all of the advantages or features disclosed by the present invention. Moreover, the abstract and the headings are merely used to aid in searches of patent files and are not intended to limit the scope of the claims of the present invention.

What is claimed is:

1. A power supply apparatus, comprising:
an input conversion stage used to receive an AC voltage and convert the AC voltage to output a DC input voltage;
a main power conversion circuit coupled to the input conversion stage and used to convert the DC input voltage so as to generate and output a main power;
an auxiliary power conversion circuit coupled to the input conversion stage and used to convert the DC input voltage so as to generate and output an auxiliary power;
a switching unit coupled to the main power conversion circuit and the auxiliary power conversion circuit, and used to receive the main power and the auxiliary power and select and output one of the main power and the auxiliary power; and
a buck power conversion circuit coupled to the switching unit and used to step down the output of the switching unit so as to generate and output a standby power.

2. The power supply apparatus as claimed in claim 1, wherein in an activation state of the power supply apparatus, the auxiliary power has a higher priority than the main power to be generated; and
in an operation state of the power supply apparatus, the main power is generated in response to the generation of the auxiliary power,
wherein the main power is greater than the auxiliary power.

3. The power supply apparatus as claimed in claim 2, wherein
in the activation state, the switching unit outputs the auxiliary power to the buck power conversion circuit; and
in the operation state, the switching unit outputs the main power to the buck power conversion circuit.

4. The power supply apparatus as claimed in claim 3, wherein the switching unit comprises:
a first diode, having an anode receiving the main power, and a cathode coupled to an input of the buck power conversion circuit; and
a second diode, having an anode receiving the auxiliary power, and a cathode coupled to the input of the buck power conversion circuit.

5. The power supply apparatus as claimed in claim 3, wherein the switching unit further selects and outputs one of the main power and the auxiliary power in response to a first control signal and a second control signal.

6. The power supply apparatus as claimed in claim 5, wherein the switching unit comprises:
a first switch used to receive the main power, wherein whether the first switch is turned on in response to the first control signal; and
a second switch used to receive the auxiliary power, wherein whether the second switch is turned on in response to the second control signal,
wherein the first switch is turned off in the activation state, and is turned on in the operation state; and
wherein the second switch is turned on in the activation state, and is turned off in the operation state.

7. The power supply apparatus as claimed in claim 6, further comprising:
a control unit coupled to the main power conversion circuit, the auxiliary power conversion circuit and the switching unit, and used to generate the first control signal and the second control signal in response to the main power and the auxiliary power.

8. The power supply apparatus as claimed in claim 6, wherein each of the first and the second switches comprises a transistor.

9. The power supply apparatus as claimed in claim 6, wherein each of the first and the second switches comprises a relay.

10. The power supply apparatus as claimed in claim 1, wherein the input conversion stage comprises:
a bridge rectifying and filtering circuit used to receive the AC voltage and perform full wave rectifying and filtering on the AC voltage, so as to output the DC input voltage.

11. The power supply apparatus as claimed in claim 10, wherein the input conversion stage further comprises:
a power factor correction converter coupled to the bridge rectifying and filtering circuit, and used to perform power factor correction on the DC input voltage.

12. The power supply apparatus as claimed in claim 11, wherein the input conversion stage further comprises:
an electromagnetic interference filter coupled between the AC voltage and the bridge rectifying and filtering circuit, and used to suppress an electromagnetic noise of the AC voltage.

13. The power supply apparatus as claimed in claim 1, wherein the main power conversion circuit is a forward power conversion circuit, a flyback power conversion circuit, an active clamp and half bridge power conversion circuit, an active clamp and full bridge power conversion circuit, or a push-pull power conversion circuit.

14. The power supply apparatus as claimed in claim 1, wherein the auxiliary power conversion circuit is a flyback power conversion circuit.
